(19) United States
(12) Patent Application Publication
(10) Pub. No.: US 2023/0178856 A1
(43) Pub. Date: Jun. 8, 2023

(54) TWO-PIECE CURRENT COLLECTOR SUB-ASSEMBLY

(71) Applicant: GM GLOBAL TECHNOLOGY OPERATIONS LLC, Detroit, MI (US)

(72) Inventors: Mitchell Stojanovski, Birmingham, MI (US); William J. Bartlomiej, II, New Haven, MI (US)

(73) Assignee: GM GLOBAL TECHNOLOGY OPERATIONS LLC, Detroit, MI (US)

(21) Appl. No.: 17/540,529

(22) Filed: Dec. 2, 2021

(51) Int. Cl. H01M 50/502; H01M 50/559

(52) U.S. Cl. CPC H01M 50/502; H01M 50/559

(57) ABSTRACT

A two-piece current collector sub-assembly includes a current collector bridge disposed on the positive terminal of a first battery cell and a current collector plate disposed on a second battery cell. The current collector plate surrounds a positive terminal of the second battery cell. The current collector bridge is coupled to the current collector plate to electrically connect the first battery cell to the second battery cell.

### INTRODUCTION

The present disclosure relates to battery assemblies and, more particularly, to two-piece current collector sub-assemblies.

Some vehicles include batteries for propulsion and/or for powering other vehicle systems. It is therefore beneficial to develop current collectors to transmit electrical power from a power supply, such as a battery pack, to other vehicle systems.

### SUMMARY

The present disclosure describes a two-piece busbar/current collector sub-assembly. This enables the material cross sectional area to be maximized within tight packaging constraints in a battery assembly while enhancing electrical, thermal and mechanical performance of the battery assembly. In addition, the ability to alter busbar/current collector thickness is achieved. By forming the current collector sub-assembly of two-pieces (instead of one-piece), the packaging space of the battery assembly can be maximized while achieving the desired electrical, thermal and mechanical performance. The plate enables the XY-plan view space taken up by the cells to be used for electrical routing while maximizing conductor surface area, and the bridge allows for variation in Z-height. The combination of the two enables tighter packaging of more material surface area as less space is dedicated to formability constraints, and the ability to vary thickness is enabled.

This two-piece busbar/current collector sub-assembly utilizes two separate pieces to link anodes and cathodes of adjacent cell groups in electric vehicle battery modules. Further, the two-piece busbar/current collector sub-assembly allows for more packaging volume to be dedicated to conductor surface area, rather than this volume being consumed by areas that are required for part formability. This is particularly useful in high ampacity applications. It also enables part thickness variation, which simplifies joining processes and could also lead to mass and cost savings.

The first piece (the current collector plate) rests on top of the cell to connect adjacent cells in parallel. The second piece (the current collector bridge) connects adjacent cell groups to the collector plate. These two easily formed components are joined together to form the current collector sub-assembly, which is then connected to the cells to complete the electrical circuit.

In an aspect of the present disclosure, a two-piece current collector sub-assembly includes first battery cell and a second battery cell, and a current collector plate disposed on a second battery cell. The current collector plate surrounds a positive terminal of the second battery cell. The two-piece current collector sub-assembly further includes a current collector bridge disposed on the positive terminal of the first battery cell. The current collector bridge is coupled to the current collector plate to electrically connect the first battery cell to the second battery cell. The current collector bridge and the current collector plate are discrete components. However, the current collect bridge and the current collector plate may be part of a one-piece structure.

In an aspect of the present disclosure, the current collector plate is configured to be placed in direct contact with a negative terminal of the second battery cell.

In an aspect of the present disclosure, the first battery cell and the second battery cell is part of a plurality of battery cells. The second battery cell is spaced apart from the first battery cell along a first direction. The plurality of battery cells is arranged in pairs of battery cells extending along a second direction. The pairs of battery cells include a first pair of battery cells and a second pair of battery cells. The second pair of battery cells is spaced apart from the second pair of battery cells along the second direction. The second direction is perpendicular to the first direction. Each of the pairs of battery cells includes the first battery cell and the second battery cell. The first pair of battery cells is laterally offset from the second pair of battery cells along the first direction. The current collector bridge is elongated along the first direction to couple the negative terminal of the second battery cell to the positive terminal of the first battery cell. The current collector bridge may be part of a battery assembly that includes irregularly grouped battery cells.

In an aspect of the present disclosure, each of the plurality of battery cells includes an electrically conductive casing and an electrically conductive protrusion extending from electrically conductive casing. The electrically conductive casing forms the negative terminal, and the electrically conductive protrusion from the positive terminal. The current collector plate defines at least one hole. The current collector plate may surround an entirety of a periphery of the electrically conductive protrusion of the at least one of the plurality of battery cells. However, the current collector plate may not surround the entire periphery of the electrically conductive protrusion.

In an aspect of the present disclosure, the current collector plate is not in contact with the electrically conductive protrusion of the second battery cell.

In an aspect of the present disclosure, the current collector bridge is configured to be directly connected to the current collector plate, and the current collector bridge is configured to be in direct contact with the positive terminal of the first battery cell.

In an aspect of the present disclosure, the current collector bridge is not in contact with the first battery cell.

In an aspect of the present disclosure, each of the plurality of battery cells is a cylindrical battery cell.

In an aspect of the present disclosure, the current collector bridge has a first bridge end and a second bridge end. The second bridge end is spaced apart from the first bridge end along the first direction. The current collector bridge has a bridge length extending from the first bridge end to the second bridge end along the first direction. The current collector bridge has a top bridge surface and a bottom bridge surface opposite the top bridge surface. The bottom bridge surface is closer to the second battery cell than the top bridge surface. The current collector bridge has a bridge thickness extending from the bottom bridge surface to the top bridge surface along a third direction. The third direction is perpendicular to the first direction. The third direction is perpendicular to the second direction. The bridge thickness is less than the bridge length to minimize heat generation.

In an aspect of the present disclosure, the current collector plate has a first plate end and a second plate end opposite the first plate end. The second plate end is spaced apart from the first plate end along the second direction. The current collector plate has a plate length extending from the first plate end to the second plate end along the second direction. The current collector plate has a top plate surface and a bottom plate surface opposite the top plate surface. The bottom plate surface is closer to the first battery cell than the bottom plate surface. The current collector plate has a plate thickness extending from the bottom plate surface to the top plate surface along the third direction. The plate thickness is less than the plate length to minimize heat generation. The plate length matches the diameter of one or more battery cells to maximizing a contact area between the current collector plate and the battery cells. The current collector plate does not need to surround the entire periphery of the battery cells.

In an aspect of the present disclosure, the current collector bridge is not in contact with the electrically conductive protrusion of the first battery cell, the current collector bridge is in direct contact with the current collector plate. The current collector plate is in direct contact with the negative terminal of the second battery cell, and the current collector bridge is in direct contact with the positive terminal of the first battery cell.

The present disclosure also describes a battery assembly. In an aspect of the present disclosure, the battery assembly includes a plurality of battery cells each having a positive terminal and a negative terminal. The plurality of battery cells includes pairs of battery cells. Each pair of battery cells includes a first battery cell and a second battery cell. The battery assembly further includes a current collector plate disposed on the second battery cell of each of the pairs of battery cells. The current collector plate surrounds the positive terminal of the first battery cell of each of the pairs of battery cells. The battery assembly further includes a plurality of current collector bridges each disposed on the positive terminal of the first battery cell of each of the pairs of battery cells. Each of the plurality of current collector bridges is coupled to the current collector plate to electrically connect the first battery cell to the second battery cell of each of the pairs of battery cells.

In an aspect of the present disclosure, the current collector plate is in direct contact with the negative terminal of the second battery cell of each of the pairs of battery cells. The second battery cell is spaced apart from the first battery cell along a first direction. The pairs of battery cells include a first pair of battery cells and a second pair of battery cells. The second pair of battery cells is spaced apart from the second pair of battery cells along a second direction. The second direction is perpendicular to the first direction. The first pair of battery cells is laterally offset from the second pair of battery cells along the first direction. The first pair of battery cells is adjacent the second pair of battery cells. Each of the plurality of current collector bridges is elongated along the first direction to couple the negative terminal of the second battery cell to the positive terminal of the first battery cell.

In an aspect of the present disclosure, each of the plurality of battery cells includes an electrically conductive casing and an electrically conductive protrusion extending from electrically conductive casing. The electrically conductive casing forms the negative terminal. The electrically conductive protrusion from the positive terminal. The current collector plate defines a plurality of thru-holes such that the current collector plate surrounds an entirety of a periphery of the electrically conductive protrusion of the second battery cell of each of the pairs of battery cells.

In an aspect of the present disclosure, the current collector plate is not in contact with the electrically conductive protrusion of the first battery cell of each of the pairs of battery cells.

In an aspect of the present disclosure, each of the plurality of current collector bridges is directly connected to the current collector plate, and each of the plurality of current collector bridges is in direct contact with the positive terminal of the first battery cell.

In an aspect of the present disclosure, each of the plurality of current collector bridges is not in contact with the electrically conductive casing of the first battery cell. Each of the plurality of battery cells is a cylindrical battery cell.

In an aspect of the present disclosure, each of the plurality of current collector bridges has a first bridge end and a second bridge end. The second bridge end is spaced apart from the first bridge end along the first direction, each of the plurality of current collector bridges has a bridge length extending from the first bridge end to the second bridge end along the first direction. Each of the plurality of current collector bridges has a top bridge surface and a bottom bridge surface opposite the top bridge surface. The bottom bridge surface is closer to the second battery cell than the top bridge surface. Each of the plurality of current collector bridges has a bridge thickness extending from the bottom bridge surface to the top bridge surface along a third direction. The third direction is perpendicular to the first direction. The third direction is perpendicular to the second direction. The bridge thickness is less than the bridge length to minimize heat generation.

In an aspect of the present disclosure, the current collector plate has a first plate end and a second plate end opposite the first plate end. The second plate end is spaced apart from the first plate end along the second direction. The current collector plate has a plate length. The plate length extends form the first plate end to the second plate end along the second direction. The current collector plate has a top plate surface and a bottom plate surface opposite the top plate surface. The current collector plate has a plate thickness extending from the bottom plate surface to the top plate surface along the third direction. The plate thickness is less than the plate length to minimize heat generation while maximizing a contact area between the current collector plate and the first battery cell.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The present disclosure will be described in conjunction with the following figures, wherein like numerals denote like elements.

FIG. 1 is a schematic isometric view of a battery assembly including a two-piece current collector sub-assembly.

FIG. 2 is a schematic cross-sectional front view of the battery assembly of FIG. 1, taken along section A-A of FIG. 1.

### DETAILED DESCRIPTION

The following detailed description is merely exemplary in nature and is not intended to limit the application and uses. Furthermore, there is no intention to be bound by expressed or implied theory presented in the preceding technical field, background, brief summary or the following detailed description. In addition, those skilled in the art will appreciate that embodiments of the present disclosure may be practiced in conjunction with a number of systems, and that the systems described herein are merely exemplary embodiments of the present disclosure.

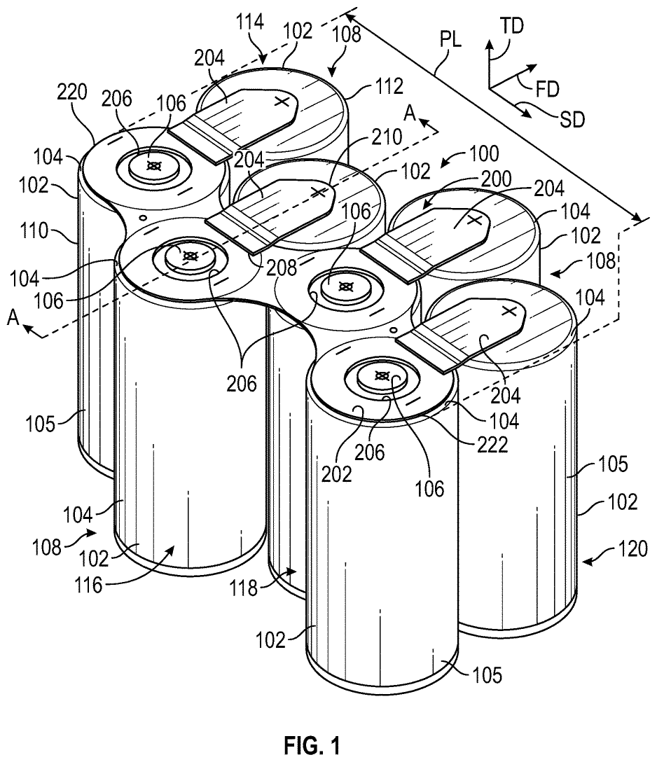

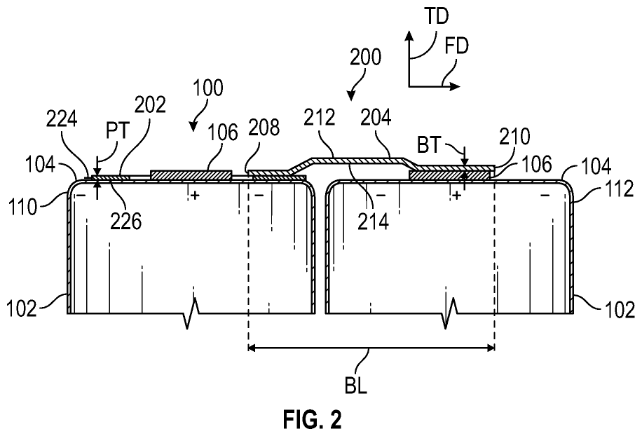

With reference to FIGS. 1 and 2, a battery assembly 100 may be used in a vehicle, such as a passenger car, for powering one or more systems of the vehicle. In some embodiments, the battery assembly 100 includes a plurality of battery cells 102. For example, the battery assembly 100 may include at least two battery cells 102. In the depicted embodiment, the battery cells 102 are cylindrical to minimize the space occupied by the battery assembly 100. The battery cells 102 may grouped in different arrangements. Each of the battery cells has a positive terminal (+) and a negative terminal (−). In the depicted embodiment, an electrically conductive casing 104 of each battery cell 102 forms the negative terminal (−), whereas an electrically conductive protrusion 106 forms the positive terminal (+). The electrically conductive protrusion 106 extends from the electrically conductive casing 104. Each battery cell 102 may also include an electrically insulating cover 105 surrounding the electrically conductive casing 104.

The battery cells 102 may be arranged in pairs 108. However, it is envisioned that the battery cells 102 may not be arranged in pairs. In the depicted embodiment, each pair 108 of battery cells 102 includes a first battery cell 112 and a second battery cell 110. The second battery cell 110 is spaced apart from the first battery cell 112 along a first direction FD. In the depicted embodiment, the battery assembly 100 includes four pairs 108 of battery cells 102. However, the battery assembly 100 may include more or fewer pairs 108 of battery cells 102. For example, in the depicted embodiment, the battery assembly 100 includes a first pair 114 of battery cells 102, a second pair 116 of battery cells 102, a third pair 118 of battery cells 102, and a fourth pair 120 of battery cells 102 spaced apart from one another along a second direction SD. The second direction is perpendicular to the first direction FD. For instance, the second pair 116 of battery cells 102 is adjacent the first pair 114 of battery cells 102 and is spaced apart from the first pair 114 of battery cells 102 along the second direction SD. Adjacent pair 108 of battery cells 102 are laterally offset from one another along the first direction FD to minimize the space occupied by the battery assembly 100. For example, the first pair 114 of battery cells 102 is laterally offset from the second pair 116 of battery cells 102 along the first direction FD.

With continued reference to FIGS. 1 and 2, the battery assembly 100 includes a two-piece current collector sub-assembly 200 for transmitting electrical power between the battery cells 102. The two-piece current collector sub-assembly 200 may be referred to as a busbar sub-assembly and includes a current collector plate 202 disposed on (and in direct contact with) the first battery cell 112 of each of the pairs 108 of battery cells 102. The current collector plate 202 is electrically connected to the negative terminal (−) of each of the first battery cells 110 of each pair 108 of battery cells 102. For this reason, the current collector plate 202 surrounds (and does not contact) the positive terminal (+) of the battery cells 102. The current collector plate 202 has a formed profile shape to minimize the space occupied by the battery assembly 100 and minimizes heat generation in the two-piece current collector sub-assembly 200.

The two-piece current collector sub-assembly 200 further includes a plurality of current collector bridges 204 each disposed on (and in direct contact with) the positive terminal (+) of the second battery cell of each of the pairs 108 of the battery cells 102. Each of the current collector bridges 204 is coupled to the current collector plate 202 to electrically connect the first battery cell 112 to the second battery cell 110 of each pair 108 of the battery cells 102. Each of the current collector bridges 204 have a planar shape to minimize the space occupied by the battery assembly 100 and minimize heat generation in the two-piece current collector sub-assembly 200.

A discussed above, the current collector plate 202 is in direct contact with the negative terminal (−), such as the electrically conductive casing 104, of the first battery cell 112 of each pair 108 of battery cells 102 to facilitate electrical power transmission between the battery cell 102 and the current collector plate 202. The current collector plate 202 may be welded to each current collector bridge 204. Each current collector bridge 204 is elongated along the first direction FD to couple the negative terminal (−) of the first battery cell 112 to the positive terminal (+) of the second battery cell 110.

The current collector plate 202 defines a plurality of thru-holes 206 to allow the current collector plate 202 to surround the entire periphery of the electrically conductive protrusion 106 (i.e., the positive terminal (+)) of the first battery cell 112 of each pair 108 of battery cells 102. Therefore, the current collector plate 202 does not contact the electrically conductive protrusion 106 of the first battery cell 112 of each pair 108 of the battery cells 102, thereby allowing transmission of electricity between the positive terminal (+) and the negative terminal (−) of the battery cells 102. Each current collector bridge 204 is directly connected to the current collector plate 202 to facilitate transmission of electricity between the battery cells 102. Further, each current collector bridge 204 is in direct contact with the positive terminal (+) of the second battery cell 110 of each pair 108 of the battery cells 102 to facilitate electrical transmission. However, each current collector bridge 204 is not in contact with the electrically conductive casing 104 (i.e., the negative terminal (−)) of the second battery cell 110. The current collector bridges 204 and the current collector plate 202 may be part of a one-piece structure.

Each current collector bridge 204 has a first bridge end and a second bridge end 210. The second bridge end 210 is spaced apart from the first bridge end 208 along the first direction FD. Each of the current collector bridges 204 has a bridge length BL extending from the first bridge end 208 to the second bridge end 210 along the first direction FD. Each of current collector bridges 204 has a top bridge surface 212 and a bottom bridge surface 214 opposite the top bridge surface 212. The bottom bridge surface 214 is closer to the first battery cell 112 than the top bridge surface 212. Each of the current collector bridges has a bridge thickness BT extending from the bottom bridge surface 214 to the top bridge surface 212 along a third direction TD. The third direction TD is perpendicular to the first direction FD and the second direction SD. The bridge thickness BT is less than the bridge length BL to minimize the space occupied by the current collector sub-assembly 200.

The current collector plate 202 has a first plate end 220 and a second plate end 222 opposite the first plate end 220. In the depicted embodiment, the second plate end 222 is spaced apart from the first plate end 220 along the second direction SD. However, if the battery cells 102 are arrange irregularly, the second plate end 222 is spaced apart from the first plate end 220 along the first direction SD. The current collector plate 202 has a top plate surface 224 and a bottom plate surface 226 opposite the top plate surface 224. The bottom plate surface 226 is closer to the first battery cell 112 than the bottom plate surface 226. The current collector plate 202 has a plate thickness PT extending from the top plate surface 224 to the bottom plate surface 226 along the third direction TD. The plate thickness PT is less than the plate length PL to minimize heat generation while maximizing a contact area between the current collector plate 202 and the first battery cell 112 of each pair 108 of the battery cells 102.

As discussed above, each of the current collector bridges 204 is not in contact with the electrically conductive protrusion 106 of the first battery cell 112 of each pair 108 of battery cells 102. Each current collector bridge 204 is in direct contact with the current collector plate 202. The current collector plate 202 is in direct contact with the negative terminal (−) of the first battery cell 112 of each pair 108 of the battery cells 102. Each current collector bridge 204 is in direct contact with the positive terminal (+) of the second battery cell 110 of each pair 108 of the battery cells 102.

The detailed description and the drawings or figures are a supportive description of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A two-piece current collector sub-assembly, comprising:
a current collector bridge disposed on a positive terminal of a first battery cell;
a current collector plate disposed on the second battery cell, wherein the current collector plate surrounds a positive terminal of the second battery cell; and
wherein the current collector bridge is coupled to the current collector plate to electrically connect the first battery cell to the second battery cell

2. The two-piece current collector sub-assembly of claim 1, wherein the current collector plate is configured to be placed in direct contact with a negative terminal of the second battery cell.

3. The two-piece current collector sub-assembly of claim 2, wherein the first battery cell and the second battery cell are part of a plurality of battery cells, the second battery cell is spaced apart from the first battery cell along a first direction, the plurality of battery cells are arranged in pairs of battery cells extending along a second direction, the pairs of battery cells includes a first pair of battery cells and a second pair of battery cells, the second pair of battery cells is spaced apart from the second pair of battery cells along the second direction, the second direction is perpendicular to the first direction, each of the pairs of battery cells includes the first battery cell and the second battery cell, the first pair of battery cells is offset from the second pair of battery cells along the second direction, and the current collector bridge is elongated along the first direction to couple the negative terminal of the second battery cell to the positive terminal of the first battery cell.

4. The two-piece current collector sub-assembly of claim 3, wherein each of the plurality of battery cells includes an electrically conductive casing and an electrically conductive protrusion extending from electrically conductive casing, the electrically conductive casing forms the negative terminal, and the electrically conductive protrusion from the positive terminal, the current collector plate defines at least one hole such that the current collector plate surrounds an entirety of a periphery of the electrically conductive protrusion of the at least one of the plurality of battery cells.

5. The two-piece current collector sub-assembly of claim 4, wherein the current collector plate is not in contact with the electrically conductive protrusion of the second battery cell.

6. The two-piece current collector sub-assembly of claim 5, wherein the current collector bridge is configured to be directly connected to the current collector plate, and the current collector bridge is configured to be in direct contact with the positive terminal of the first battery cell.

7. The two-piece current collector sub-assembly of claim 6, wherein the current collector bridge is not in contact with the first battery cell.

8. The two-piece current collector sub-assembly of claim 7, wherein each of the plurality of battery cells is a cylindrical battery cell.

9. The two-piece current collector sub-assembly of claim 8, wherein the current collector bridge has a first bridge end and a second bridge end, the second bridge end is spaced apart from the first bridge end along the first direction, the current collector bridge has a bridge length extending from the first bridge end to the second bridge end along the first direction, the current collector bridge has a top bridge surface and a bottom bridge surface opposite the top bridge surface, the bottom bridge surface is closer to the first battery cell than the top bridge surface, the current collector bridge has a bridge thickness extending from the bottom bridge surface to the top bridge surface along a third direction, the third direction is perpendicular to the first direction, the third direction is perpendicular to the second direction, and the bridge thickness is less than the bridge length.

10. The two-piece current collector sub-assembly of claim 9, wherein the current collector plate has a first plate end and a second plate end opposite the first plate end, the second plate end is spaced apart from the first plate end along the second direction, the current collector plate has a plate length extending from the first plate end to the second plate end along the second direction, the current collector plate has a top plate surface and a bottom plate surface opposite the top plate surface, the bottom plate surface is closer to the first battery cell than the bottom plate surface, the current collector plate has a plate thickness extending from the bottom plate surface to the top plate surface along the third direction, and the plate thickness is less than the plate length.

11. The two-piece current collector sub-assembly of claim 10, wherein the current collector bridge is not in contact with the electrically conductive protrusion of the first battery cell, the current collector bridge is in direct contact with the current collector plate, the current collector plate is in direct contact with the negative terminal of the second battery cell, and the current collector bridge is in direct contact with the positive terminal of the first battery cell.

12. A battery assembly, comprising:
a plurality of battery cells each having a positive terminal and a negative terminal, wherein the plurality of battery cells includes pairs of battery cells, and each of the pairs of battery cells includes a first battery cell and a second battery cell;
a current collector plate disposed on the second battery cell of each of the pairs of battery cells, wherein the current collector plate surrounds the positive terminal of the second battery cell of each of the pairs of battery cells; and
a plurality of current collector bridges each disposed on the positive terminal of the first battery cell of each of the pairs of battery cells, wherein each of the plurality of current collector bridges is coupled to the current collector plate to electrically connect the first battery cell to the second battery cell of each of the pairs of battery cells.

13. The battery assembly of claim 12, wherein the current collector plate is in direct contact with the negative terminal of the second battery cell of each of the pairs of battery cells.

14. The battery assembly of claim 13, wherein the second battery cell is spaced apart from the first battery cell along a first direction, the pairs of battery cells includes a first pair of battery cells and a second pair of battery cells, the second pair of battery cells is spaced apart from the second pair of battery cells along a second direction, the second direction is perpendicular to the first direction, the first pair of battery cells is offset from the second pair of battery cells along the second direction, the first pair of battery cells is adjacent the second pair of battery cells, and each of the plurality of current collector bridges is elongated along the first direction to couple the negative terminal of the second battery cell to the positive terminal of the first battery cell.

15. The battery assembly of claim 14, wherein each of the plurality of battery cells includes an electrically conductive casing and an electrically conductive protrusion extending from electrically conductive casing, the electrically conductive casing forms the negative terminal, the electrically conductive protrusion from the positive terminal, the current collector plate defines a plurality of thru-holes such that the current collector plate surrounds an entirety of a periphery of the electrically conductive protrusion of the second battery cell of each of the pairs of battery cells.

16. The battery assembly of claim 15, wherein the current collector plate is not in contact with the electrically conductive protrusion of the second battery cell of each of the pairs of battery cells.

17. The battery assembly of claim 16, wherein each of the plurality of current collector bridges is directly connected to the current collector plate, and each of the plurality of current collector bridges is in direct contact with the positive terminal of the first battery cell.

18. The battery assembly of claim 17, wherein each of the plurality of current collector bridges is not in contact with the electrically conductive casing of the first battery cell, and each of the plurality of battery cells is a cylindrical battery cell.

19. The battery assembly of claim 18, wherein each of the plurality of current collector bridges has a first bridge end and a second bridge end, the second bridge end is spaced apart from the first bridge end along the first direction, each of the plurality of current collector bridges has a bridge length extending from the first bridge end to the second bridge end along the first direction, each of the plurality of current collector bridges has a top bridge surface and a bottom bridge surface opposite the top bridge surface, the bottom bridge surface is closer to the first battery cell than the top bridge surface, each of the plurality of current collector bridges has a bridge thickness extending from the bottom bridge surface to the top bridge surface along a third direction, the third direction is perpendicular to the first direction, the third direction is perpendicular to the second direction, and the bridge thickness is less than the bridge length to minimize heat generation.

20. The battery assembly of claim 19, wherein the current collector plate has a first plate end and a second plate end opposite the first plate end, the second plate end is spaced apart from the first plate end along the second direction, the current collector plate has a plate length, the plate length extends form the first plate end to the second plate end along the second direction, the current collector plate has a top plate surface and a bottom plate surface opposite the top plate surface, the bottom plate surface is closer to the first battery cell than the bottom plate surface, the current collector plate has a plate thickness extending from the bottom plate surface to the top plate surface along the third direction, and the plate thickness is less than the plate length to minimize heat generation while maximizing a contact area between the current collector plate and the first battery cell.
